(19) United States
(12) Patent Application Publication
(10) Pub. No.: US 2025/0110530 A1
(43) Pub. Date: Apr. 3, 2025

(54) Notebook Computer Having Multiple Types of Input with Interchangeable Input Modules

(71) Applicant: Shengmin Wen, Phoenix, AZ (US)

(72) Inventor: Shengmin Wen, Phoenix, AZ (US)

(21) Appl. No.: 18/899,790

(22) Filed: Sep. 27, 2024

Related U.S. Application Data
(63) Continuation of application No. PCT/US2023/075664, filed on Oct. 1, 2023.

(51) Int. Cl. G06F 1/16; G06F 3/0354; G06F 3/04883

(52) U.S. Cl. CPC G06F 1/1669; G06F 1/1601; G06F 1/1616; G06F 3/03545; G06F 3/03547; G06F 3/04883

(57) ABSTRACT

A notebook computer has a conformal space that is located on the top of its main body base to hold interchangeable input modules that provide multiple types of input. An exemplary input module provides at least two different types of input, representatively typing input and handwriting input. The input module has typing input subassembly on the first side and handwriting input subassembly on the second side that is opposite to the first side. The input types may be changeable through switching sides by releasing, inverting, and putting back said input module in the conformal space that is constructed on the top of the main body base. Each input type is automatically switched on and coupled to the input/out control circuitry of the notebook computer and in a ready to use mode when the module is put into the conformal space that is on the main body base. Alternatively, user of the notebook computer may switch to an interchangeable input module of any input as desired or take the module off from the main body base of the notebook computer and work with the notebook computer in a physically detached mode while said module is wirelessly coupled to the input/out control circuitry of the notebook computer.

### CROSS-REFERENCE TO RELATED APPLICATIONS

The application is a continuation of International Application No. PCT/US2023/075664 Oct. 1, 2024, which is incorporated by reference herein.

### BACKGROUND OF THE INVENTION

### 1. Field of the Invention

The present invention generally relates to a computer system, and in a preferred embodiment thereof, more particularly relates to a notebook computer having an input module that provides at least two different input methods, representatively a keyboard for typing input and a digitizer pen tablet for handwriting or free form drawing input. The different types of input may be changed smoothly. The input module may be used physically on or off the main body base of the notebook computer according to different application circumstances and user preference. Modules that provide different types of input are interchangeable to put on or off and coupled to the notebook computer for the desired input.

### 2. Description of Related Art

Notebook computers, such as the popular clam shell style notebook computer, typically comprise a main body base with a keyboard module is assembled on its top side, and a lid module which is pivotally mounted to a rear side edge of the main body base for pivotal movement relative thereto between a generally horizontal storage and transport orientation in which the lid module is parallel to the top side of the main body base and extends across and covers the keyboard, and an upwardly and rearwardly tilted use orientation in which a display screen on the bottom side of the lid module faces the user. The main body base in general encloses the components and circuitry of the notebook computer, e.g., a microprocessor, graphics processor and related cooling system, Read-Only Memory (ROM), Random-Access Memory (RAM), internal storage hard drive, solid-state storage units, a battery, wireless connection elements, and input/output support circuitry supporting various interactive methods. The keyboard module is assembled on the top side of the main body base by fasteners (typically screws) and is not for the notebook computer users to operationally detach and re-attach frequently in its normal daily use.

The keyboard provides only the typing input method. The keyboard becomes ineffective to input scientific formulae with symbols and scientific notations. It is also impossible to draw a free form sketch, to take a handwriting digital note when reading a document or a book, to sign online documentation, or to annotate contents during an online meeting presentation. For such needs, a second input module that supports sketching and handwriting is needed. User often purchases a third-party handwriting input module such as a pen tablet or digitizer to use with the notebook computer. Such third-party module is not ergonomically friendly nor convenient to carry around with the notebook computer. To make things worse, often there are software or firmware compatibility issues between the notebook and the third-party digitizer that results in poor user experiences.

It is desirable to have the notebook computer with an input module that provides both typing and handwriting inputs. These two inputs are seamlessly integrated in this module and can switched within seconds whenever a different input is desirable. Such a notebook computer improves user experiences and use efficiency.

It is accordingly an object of the present invention to provide a notebook computer having an input module that offers different inputs and is capable of operatively effortlessly switching among these different inputs to satisfy user demands and improve user experiences.

It is the objective of this invention to provide an electronic apparatus that has typing input and handwriting input modes, where an added handwriting mode provides natural paper like writing experience without any latency, and to switch between typing and handwriting input modes is fast, smooth and easy.

### BRIEF SUMMARY OF THE INVENTION

Broadly speaking, the invention pertains to a new architecture of notebook computer. In carrying out principles of the present invention, in accordance with a preferred embodiment thereof, an electronic apparatus representatively in the form of a notebook computer is provided.

The notebook computer includes a display screen and a main body base. The main body base has a topside portion operative to releasably and changeably support a selectively variable one of a plurality of different types of input modules each operative by a user of the computer to type input, or to handwrite input, or manipulate the cursor movement on the display screen respectively. When the input module is put into place it is connected and coupled electrically to the input/out circuitry of the notebook computer and ready to use. The inputs can be changed in a matter of seconds.

The invention can be implemented in numerous ways, including as an apparatus, a device, and a computer system. Several embodiments of the invention are discussed below.

In a preferred embodiment an input module has the keyboard on a first side and the pen tablet built on a second side that is opposite to the first side. The module provides a plurality of different types of input, including (1) a keyboard for typing, (2) a keyboard/touchpad combination for typing and cursor maneuvering, and (3) a pen/tablet for handwriting.

To operatively select an input method, align the side of the module where the pogo targets are located to the side of the notebook's main body base where the pogo pins are located, release and push the module in place on top of the main body base such that the pogo targets of the module engage the pogo pins of the main body base, making the electrical connection between the module and the notebook computer's control circuitry. To change an input method, simply lift the module, invert it to make the opposite side that has the desired input method face up, and push the module back in place.

Other aspects and advantages of the invention will become apparent from the following detailed description, taken in conjunction with the accompanying drawings, illustrating by way of example the principles of the invention.

### BRIEF DESCRIPTION OF THE SEVERAL VIEWS OF THE DRAWING

The invention, together with further advantages thereof, may best be understood by reference to the embodiment(s) shown in conjunction with the accompanying drawings, in which:

FIG. 1A is a perspective view showing the prior art of a notebook computer;

FIG. 1B. is a pictorial view showing the prior art of a typical user setting;

FIG. 2 is a perspective view showing a configuration of a notebook computer according to an embodiment of this invention, in particular the embodiment showing an input module that is placed on the top of the main body base and is connected to the input/output circuitry in the main body base;

FIG. 3 is a pictorial perspective view showing the operation process of changing the inputs according to an embodiment of the invention;

FIG. 4A is a perspective drawing showing the main body base of the notebook computer with a set of pogo pins that is used to connect the input module and the input/output circuitry within the main body base of the notebook computer;

FIG. 4B is an exploded partially perspective view of the operative pogo pins set with typical pin assignments;

FIG. 5A is a perspective drawing showing the input module;

FIG. 5B is a schematic, partially cross-sectional diagram illustrating the construction of the input module;

FIG. 5C is a partially exploded, cross-sectional diagram showing the functional layer structure and elements of the input module;

FIG. 6A is a perspective view drawing showing the notebook computer having the typing input;

FIG. 6B is a pictorial drawing showing an example use setting for typing;

FIG. 6C is yet another pictorial drawing showing another example use setting for typing;

FIG. 7A is a perspective drawing showing the notebook computer having the handwriting input;

FIG. 7B is a pictorial view showing an example use setting for handwriting;

FIG. 7C is yet another pictorial drawing showing another example use setting for handwriting;

FIG. 8A is a side view drawing showing the notebook computer in an opened orientation and use condition;

FIG. 8B is a side view of notebook computer in half closing condition;

FIG. 8C shows a side view of the notebook computer in a closed orientation with the input module stowed for conveniently and securely carrying around;

FIG. 9 is a pictorial view of an office desk with the one embodiment of the present invention, showing more desk working space that is a clear contrast to the prior art of FIG. 1B.

FIG. 10 is another view of a notebook computer and input device.

### DETAILED DESCRIPTION OF THE INVENTION

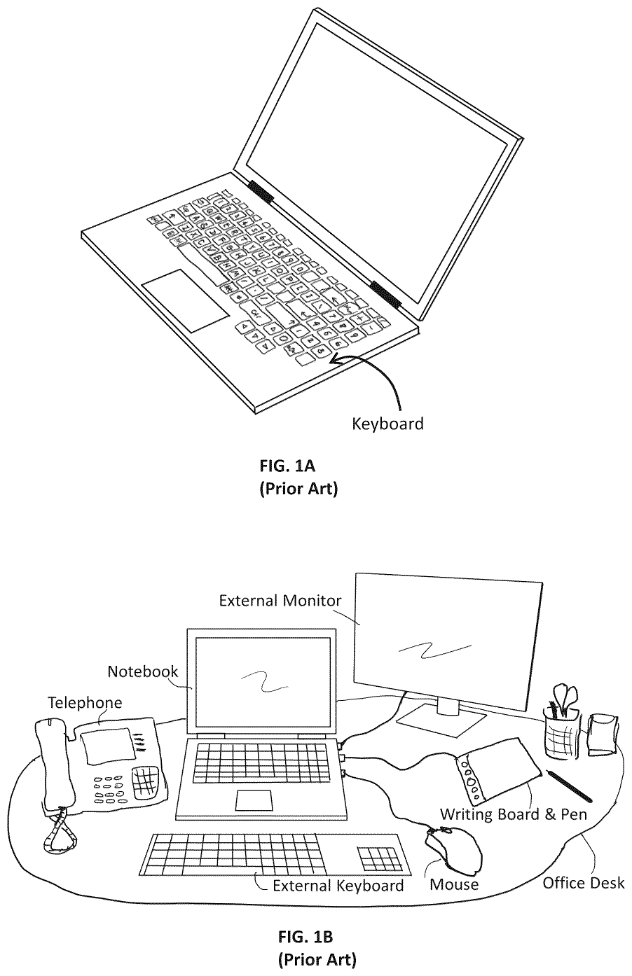

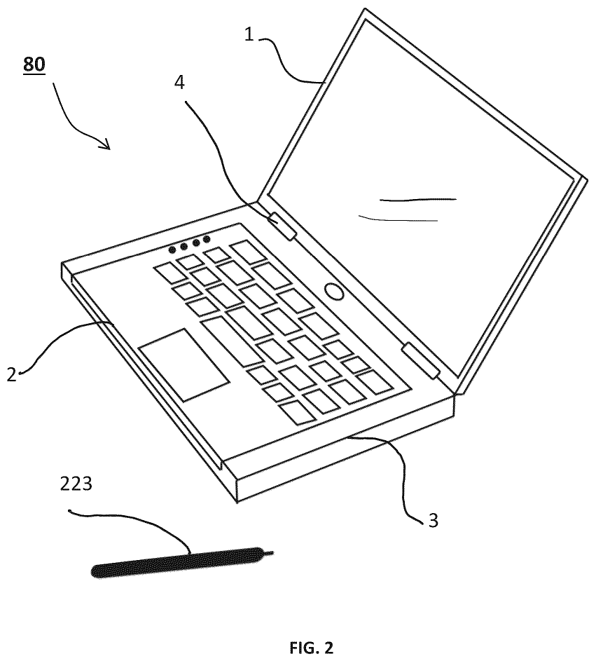

As shown in FIG. 1A, the prior art of notebook computer in the clam shell style has a keyboard subassembly, or a keyboard and touchpad combination subassembly, installed and attached to the main body base often by screws. This subassembly is only taken apart when it is in the way of a repair operation or internal components upgrade operation such as adding more DRAM modules or a large capacity hard drive. This subassembly is not freely removable and is not designed to be taken apart during normal use.

FIG. 1B shows pictorial view of a typical office desk setting of a notebook computer user as a prior art, where often at least one external larger size monitor is used, together with an external keyboard, an external tablet with its paired pen, and a mouse. These added peripherals not only take desk space but also prove to be very inconvenient to use because switching them back and forth is needed. While the keyboard is part of the notebook computer, it is not convenient to carry a pen tablet around together with a notebook computer. In addition, it is a material waste to have these multiple peripherals built individually.

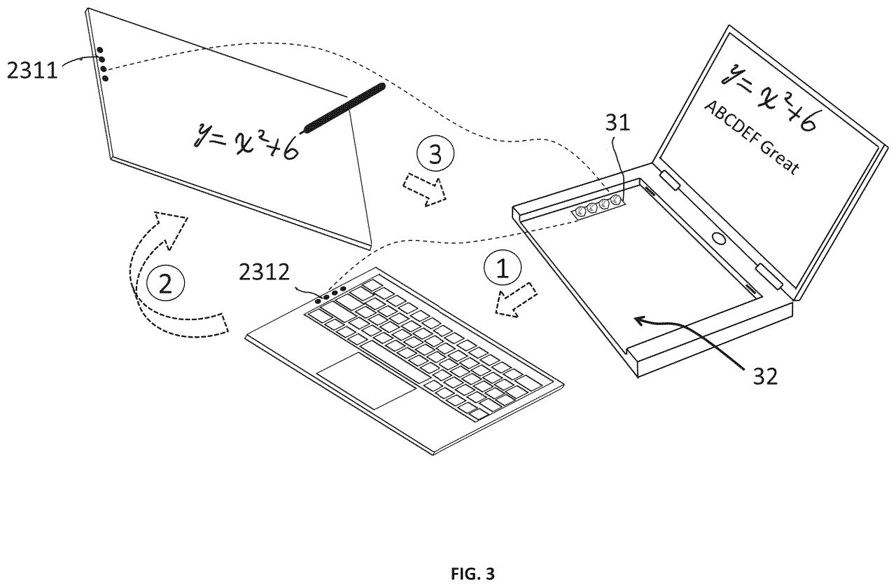

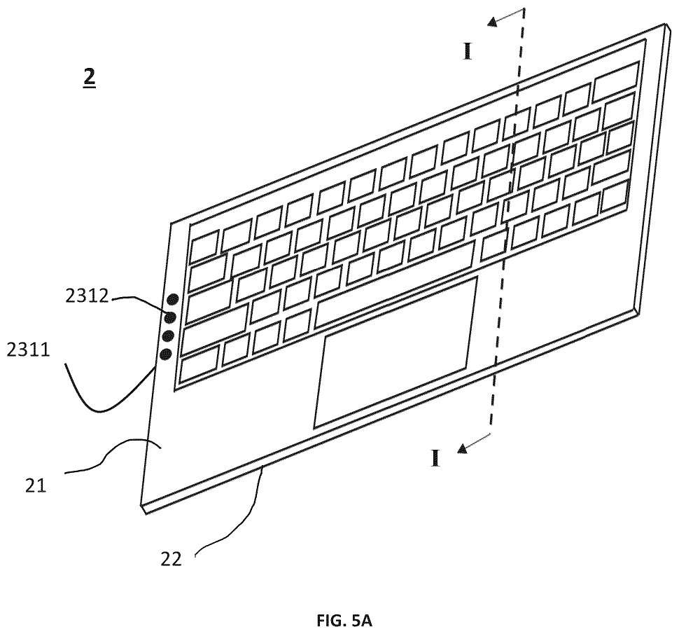

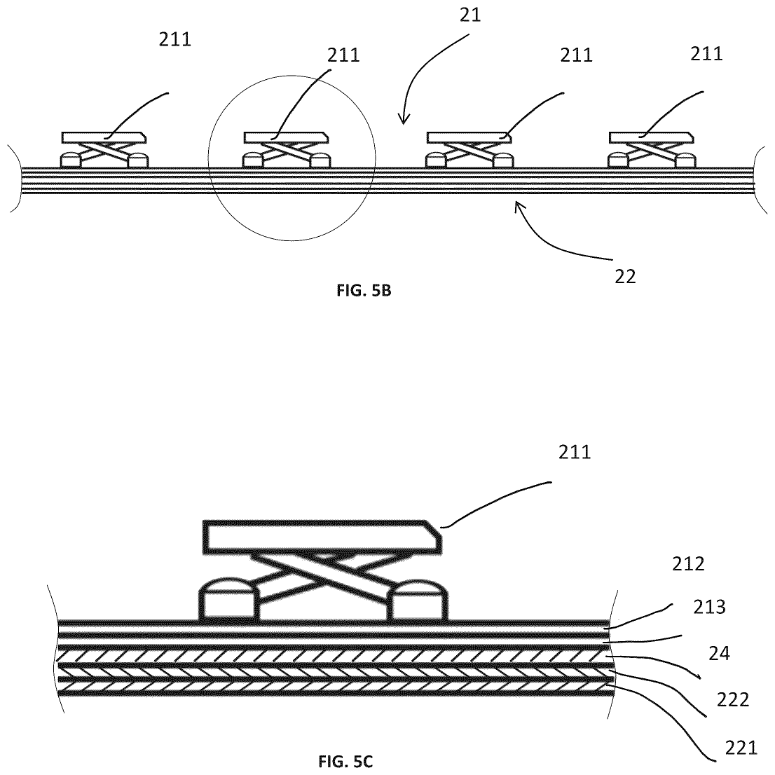

FIG. 2 shows an embodiment according to the present invention. A notebook computer 80 has a clam shell configuration in which a lid module 1 (with a display panel that displays user input and viewing output content such as image, video, text, etc.) and a main body base 3 are coupled through hinges 4 to allow opening and closing operation. In its top side that faces the display surface of the lid module, the main body base 3 has a space 32 (shown in FIG. 3) that is conformal to the external contour shape of an input module 2 for receiving the input module 2 between lid module 1 and main body base 3. The input module 2 is changeable and can be freely and effortlessly taken out of or put back into this conformal space. The input module 2 comprises two different subassemblies that are constructed respectively on its two opposite sides of large surface area, namely a keyboard subassembly 21 for typing input and a tablet subassembly 22 plus a pen 223 for the handwriting input. Details of this input module 2 are shown in FIGS. 5A, 5B and 5C. The main body base 3 further in general encloses the components and circuitry (not shown) of the notebook computer, e.g., a central processing unit (CPU), graphics processor and related cooling system, Read-Only Memory (ROM), Random-Access Memory (RAM), internal storage hard drive, solid-state storage units, a battery, wireless connection elements, USB connectors, thunderbolt connectors, radio-frequency data transmission port, and various input/output support circuitry.

FIG. 3 is a pictorial and schematic drawing that illustrates the process of interchanging inputs provided by input module 2. Assume the input module 2 of the notebook computer is in the configuration of keyboard or a keyboard/touchpad input. When a handwriting input is desired, there are three sequential steps involved to make the switch from the typing input to the handwriting input. Step \textcircled{1}, the user releases the input module 2 from the conformal space 32, disconnecting the pogo targets 2311 which is coupled to the main body input/output circuitry for the typing input through the pogo pins 31; step \textcircled{2}, the user flips the input module upside down, making the handwriting side face up; step \textcircled{2}, the user aligns the pogo targets 2312 which is for the handwriting input to the pogo pins 31, and inserts the input module 2 back into the conformal space 32. Similar sequential steps apply if the notebook computer is in the configuration having the handwriting input and it is desired to switch to the typing input. These two inputs are seamlessly changeable within seconds, greatly improving user experience and work efficiency.

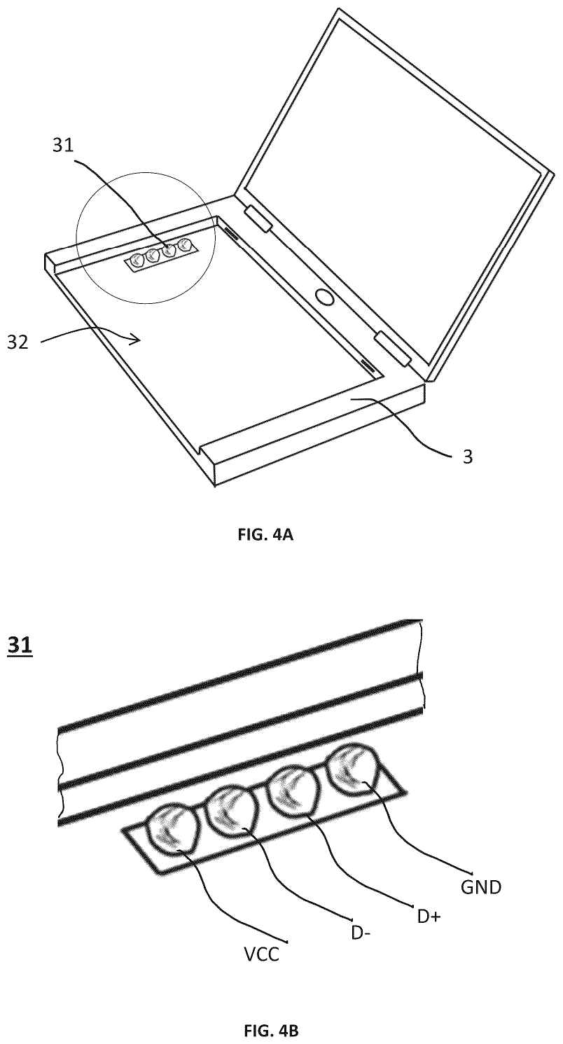

FIG. 4A is a perspective view of the main body base 3. The base 3 has on its top a conformal space 32 which accommodates the input module 2, and a set of pogo pins 31 which provides electrical connection, including power delivery from within the main body base 3 to the input module 2 and data and command communication between the input module 2 and the input/output circuitry of motherboard within the main body base 3. FIG. 4B is an exploded view of the pogo pins set 31. This embodiment has one power delivery pin, VCC, one ground pin GND, two pins D+ and D− acting as a differential data signal transmission pair.

FIGS. 5A, 5B and 5C are highly schematic perspective and cross-sectional views to illustrate the construction of the input module 2. FIG. 5A is a perspective view of the input module 2. The input module has a thin plate shape, typically less than 15 mm in thickness and larger than 250 mm in diagonal length. The module has two opposite sides with large area, sides 21 and 22. A plurality of keys for typing, a touchpad for cursor movement, and a set of pogo targets 2312 that connects to pogo pins set 31 to enable handwriting input are arranged on side 21. A writing surface and pogo targets 2311 that connect to pogo pins set 31 to enable typing input are arranged on side 22 (not visible in this figure). When side 21 is in use, the pogo targets 2311 on the opposite side 22 are coupled physically and electrically to the pogo pins set 31, making connection between the typing and touchpad circuitry of input module 2 and the input/output circuitry within the main body base 3 and therefore providing the typing input. Similarly, when side 22 is in use, the pogo targets 2312 on the opposite side 21 are coupled physically and electrically to the pogo pins set 31, making connection between the handwriting circuitry of input module 2 and input/output circuitry within the main body base 3 and therefore providing the handwriting input. FIG. 5B provides a full cross-sectional view of the input module 2 through cutting plane line I-I of FIG. 5A. Input module 2 is a layering stacking structure. The keyboard for typing input is constructed on side 21, which comprises a plurality of vertically movable keys and circuitry underneath these keys. The pen tablet for handwriting input is constructed on the side 22 that is opposite to side 21, which comprises sensing layers of carefully designed and patterned metal loops that electromagnetically couple to a writing pen 223. The electromagnetic resonance (EMR) between these layers and the pen generates inductive current and signals when the writing pen is moving close to or on the writing surface that is laminated above these sensing layers.

FIG. 5C is an exploded schematic view of the cross-section under one example key 211. A thin and stiffened plate structure 24 is at the core of the input module 2. The plate 24 is light weight, flat, and strong. It may be built with metal such as aluminum, titanium, or carbon fiber reinforced plastic. Plate 24 is the base that supports the vertical movement of the keys 211 for the typing input on one side and supports a flat surface for the handwriting input on the opposite side. The keyboard for typing comprises three essential elements that are stacked on top of each other on plate 24. The first element is the key set 211 that provides the typing input interface and a switch mechanism that are designed to have an ergonomic travel distance typically within the range of 0.5 mm to 4.0 mm when a key is depressed. The second element is an electrical subassembly 212 that is below the key set 211. The subassembly 212 generates signals to the typing controller (not shown here in the figures) of the keyboard when a key is depressed. This subassembly may be a composite structure that includes a three-layer membrane, where metal traces separated by a center layer with holes through which the two outer layers can be shorted when a key is depressed. The third element 213 is typically the keyboard bracket, where keys 211 are attached and anchored onto the plate 24. The pen tablet for handwriting comprises three major elements. A first element, the cover layer 221 is a surface that provides paper like writing experience. A second element, sensing structure 222 has periodic patterned metal loops that may be vacuum laminated on plate 24, with sensing structure 222 being sandwiched between the support plate 24 and the writing layer 221. A third element, a writing pen 223 has metal coils built within it such that an electromagnetic resonance (EMR) between sensing structure 222 and pen 223 occurs when these two elements are physically in touch or close enough (can be as far away as 10 mm). The EMR induced current signals in sensing structure 222 are converted to handwriting or free drawing inputs by a controller (not shown here) and firmware. On occasion, to ensure signal integrity, a shielding layer (not shown here because sometimes it is just a thin coating) may be sandwiched between layer 222 and support plate 24.

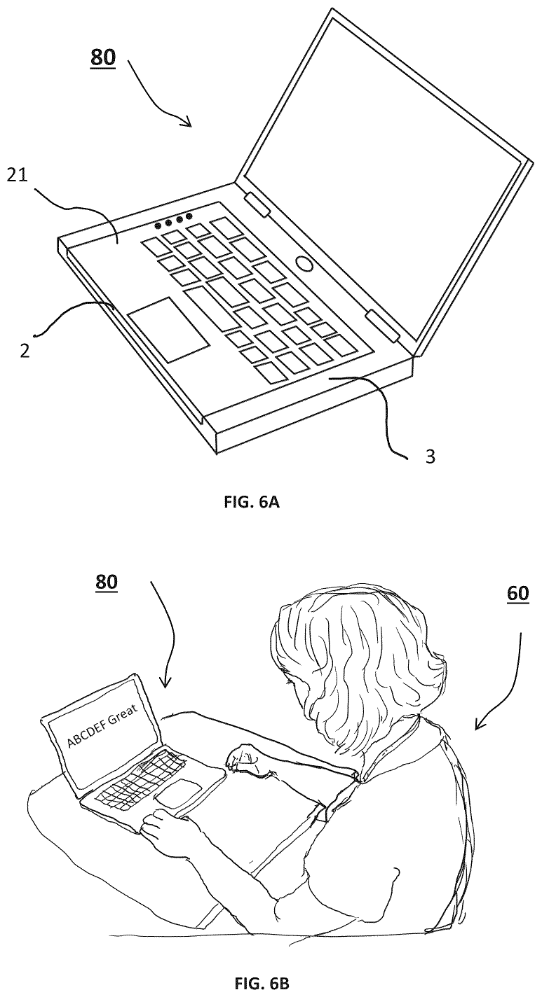

FIG. 6A is a perspective view of a new and improved notebook computer 80 constructed in accordance with the present invention when the input module 2 is placed into the conformal space 32 of main body base 3 with the side 21 facing up for the typing input. FIG. 6B is a pictorial view of a new and improved notebook computer 80 constructed in accordance with the present invention being used by user 60 for the typing input. FIG. 6C is a pictorial view of a user 60 who has taken the input module off from the notebook computer's main body base 3 and put it in a convenient place with an ergonomic position for the typing input. In this embodiment, the coupling connection between the input module and the main body base is wireless.

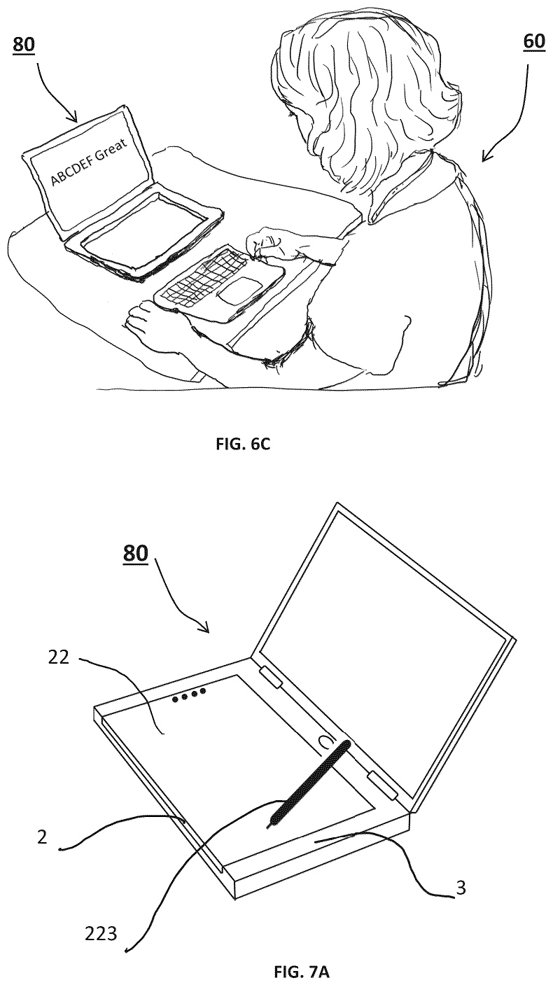

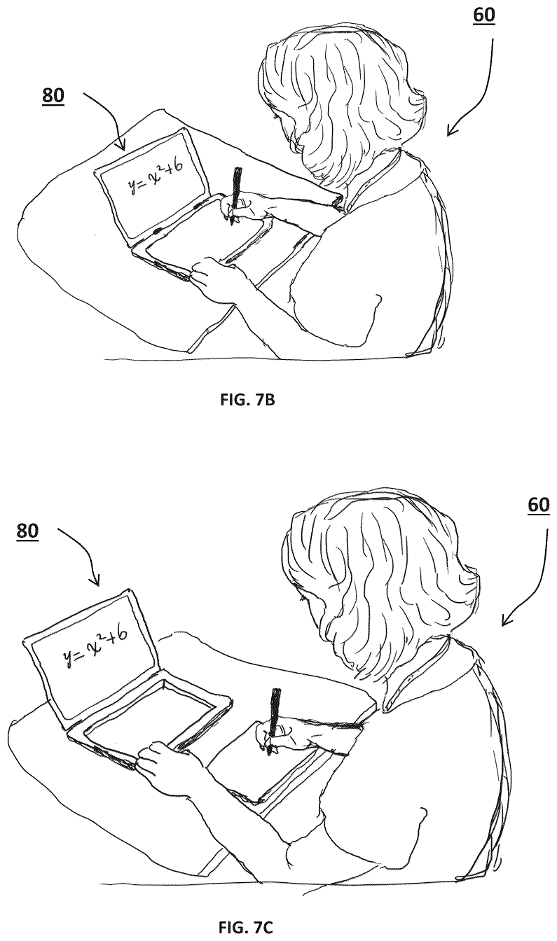

FIG. 7A is a perspective view of a new and improved notebook computer 80 constructed in accordance with the present invention when the input module 2 is put into the conformal space 32 of main body base 3 with the side 22 facing up for the handwriting input. FIG. 7B is a pictorial view of a new and improved notebook computer 80 constructed in accordance with the present invention being used by user 60 for the handwriting input. FIG. 7C is a pictorial view of a user 60 who has taken the input module off from the notebook computer's main body base 3 and put it in a convenient place with an ergonomic position to write and draw. In this embodiment, the coupling connection between the input module and the main body base is wireless.

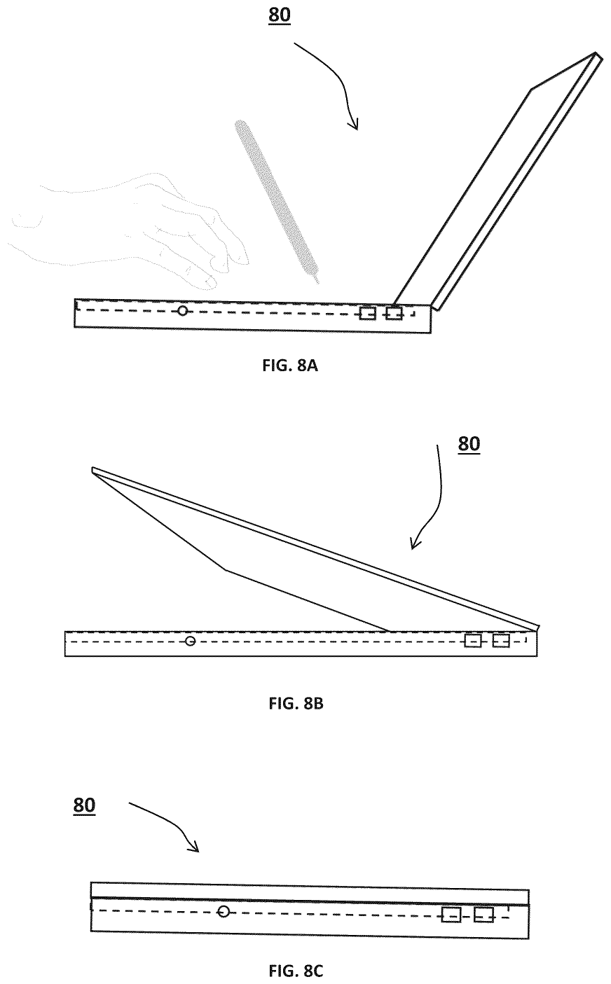

FIG. 8A is an illustrative side view drawing showing an exemplary notebook computer in an open position for user to utilize any one of a plurality of input modules, for example a keyboard module for typing and a pen tablet module for handwriting; FIG. 8B is an illustrative side view of an exemplary notebook computer in half closing position; FIG. 8C shows an illustrative side view of an exemplary notebook computer of this invention in a closed position with the input module 2 being stowed in the main body base for convenient and secure transportation;

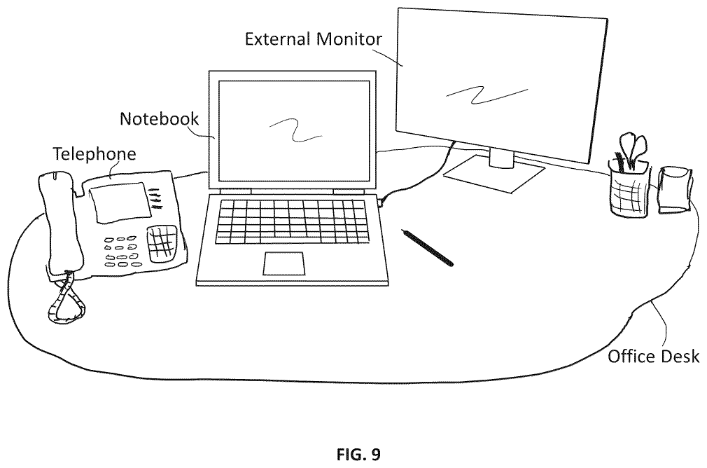

FIG. 9 is a pictorial illustration of a typical office desk when a user uses an exemplary notebook computer of the present invention. In comparison to FIG. 1B which illustrates the prior art, the external keyboard and external pen tablet is eliminated. The desktop is cleaner with more working space.

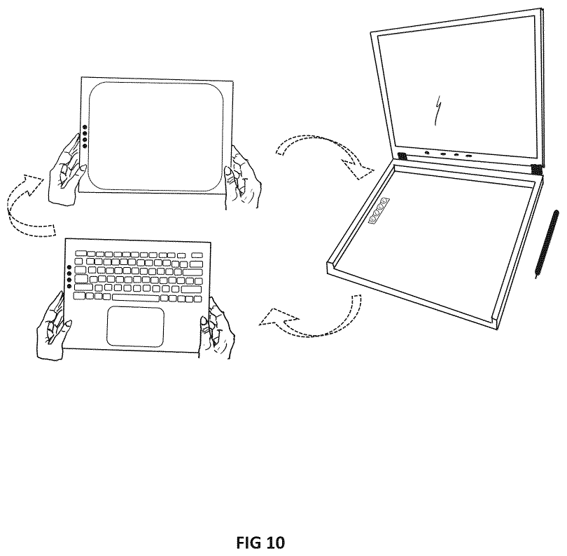

FIG. 10 is another view of a notebook computer and input device as described herein.

Obviously, many modifications and variations of the present invention are possible in light of the above exemplary embodiments that have been described in language specific to structural features and/or methodological acts. Thus, it is to be understood that the implementations defined in the appended claims are not necessarily limited to the specific features or acts described. Rather, the specific features and acts are disclosed as example forms of implementing the claimed features.

1. A notebook computer comprising:
a main body base comprising a support structure enclosing electrical components of the notebook computer including input/output circuitry;
a lid module having an integrated display screen, the lid module pivotably coupled to the main body base by a hinge in a clam shell configuration;
a removable input module structured to fit within a conformal space of the main body base, including:
a keyboard subassembly including a plurality of keys, an electrical circuitry layer to generate keyboard signals responsive to interactions with the keys, and a bracket layer for anchoring the keys;
a writing tablet subassembly including a writing surface and a sensor layer below the writing surface including patterned metal loops for generating EMR sensing signals responsive to a writing element interacting with the writing surface;
a stiffener plate having a first surface coupled to the bracket layer of the keyboard subassembly to provide structural support for the plurality of keys, and the stiffener plate having a second surface opposite the first surface, wherein the sensor layer of the writing tablet subassembly is laminated on the second surface of the stiffener plate; and
a communication interface to communicate the keyboard signals and the EMR sensing signals to the input/output circuitry of the notebook computer,
wherein the removable input module is switchable between a keyboard usage mode in which the keyboard subassembly faces externally to the conformal space of the main body base to enable user input via the keyboard subassembly, and a writing tablet usage mode in which the writing tablet subassembly faces externally to the conformal space of the main body base to enable user input via the writing tablet subassembly.

2. The notebook computer of claim 1, wherein the keyboard subassembly further comprises a touchpad module for maneuvering cursor movement and menu command execution.

3. The notebook computer of claim 1, wherein the main body base comprises a base connector for electrically connecting to one or more input module connectors on the removable input module.

4. The notebook computer of claim 3, wherein the base connector and the one or more input module connectors are pogo connectors.

5. The notebook computer of claim 3, wherein the base connector is on a top surface of the conformal space, and wherein the one or more input module connectors include a writing tablet connector on a first side of the input module adjacent to the keyboard subassembly for coupling with the base connector of the main body base when the writing tablet subassembly is externally facing, and a keyboard connector on a second side of the input module adjacent to the writing tablet subassembly for coupling with the base connector of the main body base when the keyboard subassembly is externally facing.

6. The notebook computer of claim 1, further comprising a pen having a resonant circuit, and a pen position microprocess unit to detect pen position based on the EMR sensing signals generated when the pen interacts with the writing surface.

7. The notebook computer of claim 6 wherein the pen position microprocess unit is configured to obtain the EMR sensing signals induced in the sensor layer when the pen interacts with the writing tablet subassembly, process the EMR sensing signals to generate pen induced signals encoding at least one of position of the pen, stroke weight of the pen, and tip pressure level of the pen, and output the pen induced signals to the input/output circuitry of the notebook computer.

8. The notebook computer of claim 1, wherein the conformal space has a rectangular shape with rounded corners and a depth that matches a thickness of the removable input module.

9. The notebook computer of claim 1, wherein the removable input module is configured to be used wirelessly when removed from the conformal space.

10. A notebook computer comprising:
a main body base comprising a support structure enclosing electrical components of the notebook computer including input/output circuitry, the main body base including a base connector coupled to the input/output circuitry;
a lid module having an integrated display screen, the lid module pivotably coupled to the main body base by a hinge in a clam shell configuration;
a removable input module structured to fit within a conformal space of the main body base, the removable input module including:
a keyboard subassembly including a plurality of keys, an electrical circuitry layer to generate keyboard signals responsive to interactions with the keys, and a bracket layer for anchoring the keys;
a writing tablet subassembly including a writing surface and a sensor layer for generating sensor signals in response to a writing element interacting with the writing surface;
a stiffener plate having a first surface coupled to the bracket layer of the keyboard subassembly to provide structural support for the plurality of keys, and the stiffener plate having a second surface opposite the first surface, wherein the sensor layer of the writing tablet subassembly is laminated on the second surface of the stiffener plate;
a communication interface to communicate the keyboard signals and the sensor signals to the electrical components of the notebook computer;
a writing tablet connector on a first side of the input module adjacent to the keyboard subassembly for coupling with the base connector of the main body base when the writing tablet subassembly is externally facing; and
a keyboard connector on a second side of the input module adjacent to the writing tablet subassembly for coupling with the base connector of the main body base when the keyboard subassembly is externally facing,
wherein the removable input module is switchable between a keyboard usage mode in which the keyboard subassembly faces externally to the conformal space of the main body base to enable user input via the keyboard subassembly, and a writing tablet usage mode in which the writing tablet subassembly faces externally to the conformal space of the main body base to enable user input via the writing tablet subassembly.

11. The notebook computer of claim 10, wherein the keyboard subassembly further comprises a touchpad module for maneuvering cursor movement and menu command execution.

12. The notebook computer of claim 10, wherein the base connector, the writing tablet connector, and the keyboard connector are pogo connectors.

13. The notebook computer of claim 10, wherein the keyboard connector is coupled to the electrical circuitry layer of the keyboard subassembly to communicate the keyboard signals, and wherein the writing tablet connector is coupled to the sensor layer of the writing tablet subassembly to communicate the sensor signals.

14. The notebook computer of claim 10, further comprising a pen for interacting with the writing tablet subassembly and a pen position microprocess unit to detect pen position based on the sensing signals.

15. The notebook computer of claim 14, wherein the pen position microprocess unit generates pen induced signals encoding at least one of position of the pen, stroke weight of the pen, and tip pressure level of the pen, and outputs the pen induced signals to the input/output circuitry of the notebook computer.

16. The notebook computer of claim 10, wherein the conformal space has a rectangular shape with rounded corners and a depth that matches a thickness of the removable input module.

17. The notebook computer of claim 10, wherein the removable input module is configured to be used wirelessly when removed from the conformal space.

18. A removable input module structured to fit within a conformal space of a main body base of a notebook computer, and switchable between a keyboard usage mode and a writing tablet usage mode, the removable input module comprising:
a keyboard subassembly including a plurality of keys, an electrical circuitry layer to generate keyboard signals responsive to interactions with the keys, and a bracket layer for anchoring the keys;
a writing tablet subassembly including a writing surface and a sensor layer including patterned metal loops for generating EMR sensing signals responsive to a writing element interacting with the writing surface;
a stiffener plate having a first surface coupled to the bracket layer of the keyboard subassembly to provide structural support for the plurality of keys, and the stiffener plate having a second surface opposite the first surface, wherein the sensor layer of the writing tablet subassembly is laminated on the second surface of the stiffener plate; and
a communication interface to communicate the keyboard signals and the EMR sensing signals to the notebook computer,
wherein the removable input module is operable in the keyboard usage mode when positioned such that the keyboard subassembly faces externally to the conformal space of the main body base to enable user input via the keyboard subassembly, and the removeable input module is operable in the writing tablet usage mode when positioned such that the writing tablet subassembly faces externally to the conformal space of the main body base to enable user input via the writing tablet subassembly.

19. The removable input module of claim 18, further comprising:
a writing tablet connector on a first side of the input module adjacent to the keyboard subassembly for coupling with a base connector of the main body base when the writing tablet subassembly is externally facing; and
a keyboard connector on a second side of the input module adjacent to the writing tablet subassembly for coupling with a base connector of the main body base when the keyboard subassembly is externally facing.

20. The removable input module of claim 19, wherein the base connector, the writing tablet connector, and the keyboard connector are pogo connectors.
